(19) United States
(12) Patent Application Publication
(10) Pub. No.: US 2016/0018582 A1
(43) Pub. Date: Jan. 21, 2016

(54) BACKLIGHT HAVING COLLIMATING REFLECTOR

(71) Applicant: HEWLETT-PACKARD DEVELOPMENT COMPANY, L.P., West Houston, TX (US)

(72) Inventors: Marco Fiorentino, Mountain View, CA (US); David A. Fattal, Mountain View, CA (US)

(21) Appl. No.: 14/772,358

(22) PCT Filed: Mar. 13, 2013
(86) PCT No.: PCT/US2013/031029

§ 371 Date: Sep. 2, 2015

(51) Int. Cl. F21V 8/00

(52) U.S. Cl. CPC G02B 6/0018; G02B 6/002

(57) ABSTRACT

A backlight includes a plate light, guide to guide light, a light source to produce light, and a collimating reflector to substantially collimate the produced light. The collimating reflector also is to direct that collimated light into the plate light guide as guided light of the plate light guide. A portion of the guided light in the backlight is to be emitted from a surface of the backlight as emitted light.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Among the most commonly found electronic displays are the cathode ray tube (CRT), plasma display panels (PDPs), liquid crystal displays (LCDs), electroluminescent (EL) displays, organic light emitting diode (OLED) and active matrix OLEDs (AMOLED) displays, electrophoretic (EP) displays and various displays that employ electromechanical or electrofluidic light modulation (e.g., digital micromirror devices, electrowetting displays, etc.). In general, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given their lack of an ability to emit light.

To overcome various application-related limitations of passive displays associated with emitted light, many passive displays are coupled to an external light source. The coupled light source may allow these otherwise passive displays to emit light and function substantially as an active display. Examples of such coupled light sources are backlights. Backlights are light sources (often panel light sources) that are placed behind an otherwise passive display to illuminate the passive display. For example, a backlight may be coupled to an LCD or an EP display. The backlight emits light that passes through the LCD or the EP display. The light emitted is modulated by the LCD or the EP display and the modulated light is then emitted, in turn, from the LCD or the EP display. Often backlights are configured to emit white light. Color filters are then used to transform the white light into various colors used in the display. The color filters may be placed at an output of the LCD or the EP display (less common) or between the backlight and the LCD or the EP display, for example.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1A illustrates a cross sectional view of a backlight, according to an example consistent with the principles described herein.

FIG. 1B illustrates a plan view of a portion of the backlight illustrated in FIG. 1A, according to an example consistent with the principles described herein.

FIG. 1C illustrates a perspective view of the backlight illustrated in FIG. 1A, according to an example consistent with the principles described herein.

FIG. 2A illustrates a schematic representation of a parabolic shaped reflector in a first plane, according to an example consistent with the principles described herein.

FIG. 2B illustrates a schematic representation of the parabolic shaped reflector of FIG. 2A in a second plane, according to an example consistent with the principles described herein.

FIG. 3 illustrates a cross sectional view of a lens between a collimating reflector and a light source, according to an example consistent with the principles described herein.

FIG. 4 illustrates a cross sectional view of a portion of a backlight including a diffraction grating, according to an example consistent with the principles described herein.

FIG. 5 illustrates a block diagram of an electronic display, according to an example consistent with the principles described herein.

FIG. 6 illustrates a flow chart of a method of backlighting, according to an example consistent with the principles described herein.

Certain examples have other features that are one of in addition to and in lieu of the features illustrated in the above -referenced figures. These and other features are detailed below with reference to the above-referenced figures.

### DETAILED DESCRIPTION

Examples in accordance with the principles described herein provide backlighting that employs collimated light guided within a light guide. The backlighting may be used to illuminate an electronic display, for example. In particular, backlighting of an electronic display described herein employs a collimating reflector to collimate light from a substantially uncollimated light source. The collimated light produced by the collimating reflector is then directed into and guided within the light guide. Additionally, the collimated light may directed into the light guide at a non-zero angle relative to a surface of the light guide, according some examples. In some examples, a portion of the collimated light in the light guide may be coupled out using a diffraction grating to produce light for backlighting the electronic display. In other examples, other means including, but not limited to, anisotropic scattering may be employed to couple out the guided light. Backlighting in accordance with the principles described herein may be applicable to a variety of electronic display configurations including, but not limited to, two-dimensional (2-D) displays and three-dimensional (3-D) displays.

Herein, a ‘collimating reflector’ is defined as a reflector that accepts a generally diverging beam of light and redirects or reflects the light as substantially collimated light. According to various examples, collimated light produced by the collimating reflector may be collimated in a particular direction (i.e., a collimation direction). By definition, a ‘collimation direction’ is a direction orthogonal to a propagation direction of the light in which there is little or no divergence of the light. In particular, rays of collimated light in the collimation direction are substantially parallel to one another, by definition herein.

In some examples, the collimating reflector may collimate light in a first direction but not in a second direction. For example, the light may be collimated in a horizontal direction (e.g., parallel with a surface of a light guide) but not in a vertical direction (e.g., perpendicular with the light guide surface). Rays of light in the horizontally collimated light when viewed in a cross section taken in the horizontal direction are substantially parallel. However, rays of light in horizontally collimated light when viewed in a vertical cross section may not be parallel and the horizontally collimated light may still exhibit substantial divergence in the vertical direction, for example. On the other hand, light collimated in two substantially orthogonal directions may exhibit little or no divergence in any direction orthogonal to the propagation direction of the light and may be termed dual collimated light or simply a ‘beam’ of collimated light. In a collimated light beam, the light rays are all substantially parallel to one another regardless of the cross section direction in which the collimated light beam is viewed.

In some examples, the collimating reflector may be a portion of a parabolic cylinder. A parabolic cylinder reflector collimates reflected light in a direction perpendicular to an axis of the cylinder, for example. In other examples, the collimating reflector collimates light in two directions that are substantially orthogonal to one another (e.g., parallel and perpendicular to a light guide surface). For example, the collimating reflector may be a portion of a paraboloid reflector. A paraboloid reflector collimates reflected light in two orthogonal directions to produce a beam of collimated light.

In some examples, the collimating reflector may further direct the collimated light at a non-zero angle. For example, instead of exiting the collimating reflector in a horizontal direction, the collimated light may propagate away from the collimating reflector at an angle θ measured from horizontal. In some examples, the non-zero angle is achieved by tilting or canting the collimating reflector. In other examples, the collimating reflector is a shaped paraboloid reflector having a surface defined by a solution to equation (1)

\sqrt{x²+y²+z²}=z·sin θ+x·cos θ−c (1)

where x and y lie in the horizontal plane, z is in the vertical direction, and c is scale factor. In some examples, the scale factor c is two times a focal length/of the shaped paraboloid reflector.

Herein, a ‘diffraction grating’ is defined as a plurality of features arranged to provide diffraction of light incident on the features. A ‘directional diffraction grating’ is a diffraction grating that provides diffraction selectively for light propagating in a predetermined or particular direction. Further by definition herein, the features of a diffraction grating are features formed one or both of in and on a surface of a material that supports propagation of light. The material may be a material of a light guide, for example. The features may include any of a variety of features or structures that diffract light including, but not limited to, grooves, ridges, holes and bumps on the material surface. For example, the diffraction grating may include a plurality of parallel grooves in the material surface. In another example, the diffraction grating may include a plurality of parallel ridges rising out of the material surface. A diffraction angle θₘ of light diffracted by a periodic diffraction grating may be given by equation (2) as:

$${θ}_{m} = {sin}^{- 1} ( \frac{m λ}{d} - sin {θ}_{i} ) \qquad ( 2 )$$

where λ is a wavelength of the light, m is a diffraction order, d is a distance between features of the diffraction grating, and θᵢ is an angle of incidence of the light on the diffraction grating.

In some examples, the plurality of features may be arranged in a periodic array. In some examples, the diffraction grating may include a plurality of features arranged in a one-dimensional (1-D) array. For example, a plurality of parallel grooves is a 1-D array. In other examples, the diffraction grating may be a two-dimensional (2-D) array of features. For example, the diffraction grating may be a 2-D array of bumps on a material surface. The features (e.g., grooves, ridges, holes, bumps, etc.) may have any of a variety of cross sectional shapes or profiles that provide diffraction including, but not limited to, one or more of a rectangular profile, a triangular profile and a saw tooth profile.

Herein, ‘diffractive coupling’ is defined as coupling of an electromagnetic wave (e.g., light) across a boundary between two materials as a result of diffraction (e.g., by a diffraction grating). For example, a diffraction grating may be used to couple out light propagating in a light guide by diffractive coupling across a boundary of the light guide. The diffractive coupling substantially overcomes total internal reflection that guides the light within the light guide to couple out the light, for example.

Further herein, a ‘light guide’ is defined as a structure that guides light within the structure using total internal reflection. In particular, the light guide may include a ‘core’ that is substantially transparent at an operational wavelength of the light guide, according to some examples. In some examples, the term ‘light guide’ generally refers to a dielectric optical waveguide that provides total internal reflection to guide light at an interface between a dielectric material of the light guide and a material or medium that surrounds that light guide. For example, a refractive index of the light guide material may be greater than a refractive index of the surrounding medium to provide total internal reflection of the guided light. In some examples, the light guide may include a coating in addition to or instead of the aforementioned refractive index difference to provide the total internal reflection. The coating may be a reflective coating, for example. According to various examples, the light guide may be any of a variety of light guides including, but not limited to, a slab or plate optical waveguide guide.

Further herein, the term ‘plate’ when applied to a light guide as in a ‘plate light guide’ is defined to mean piecewise or differentially planar. In particular, a plate light guide is defined as a light guide configured to guide light in two substantially orthogonal directions bounded by a top surface and a bottom surface of the light guide. Further, by definition, the top and bottom surfaces are both separated from one another and substantially parallel to one another in a differential sense. As such, within any differentially small region of the plate light guide, the top and bottom surfaces are substantially parallel or co-planar. In some examples, a plate light guide may be substantially flat (e.g., confined to a plane) and so the plate light guide is a planar light guide. In other examples, the plate light guide may be curved in one or two orthogonal dimensions. For example, the plate light guide may be curved in a single dimension to form a cylindrical shaped plate light guide. In various examples however, any curvature has a radius of curvature sufficiently large to insure that total internal reflection is maintained within the plate light guide to guide light.

Further still, as used herein, the article ‘a’ is intended to have its ordinary meaning in the patent arts, namely ‘one or more’. For example, ‘a reflector’ means one or more reflectors and as such, ‘the reflector’ means ‘the reflector(s)’ herein. Also, any reference herein to ‘vertical’, ‘horizontal’, ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Moreover, examples herein are intended to be illustrative only and are presented for discussion purposes and not by way of limitation.

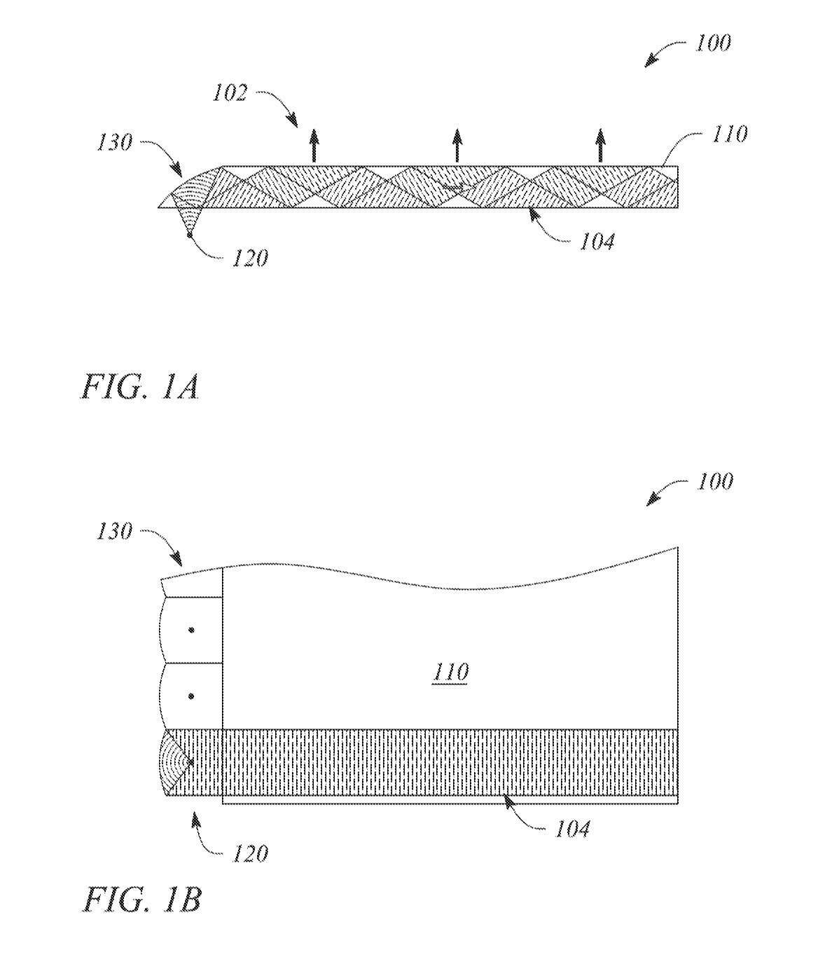

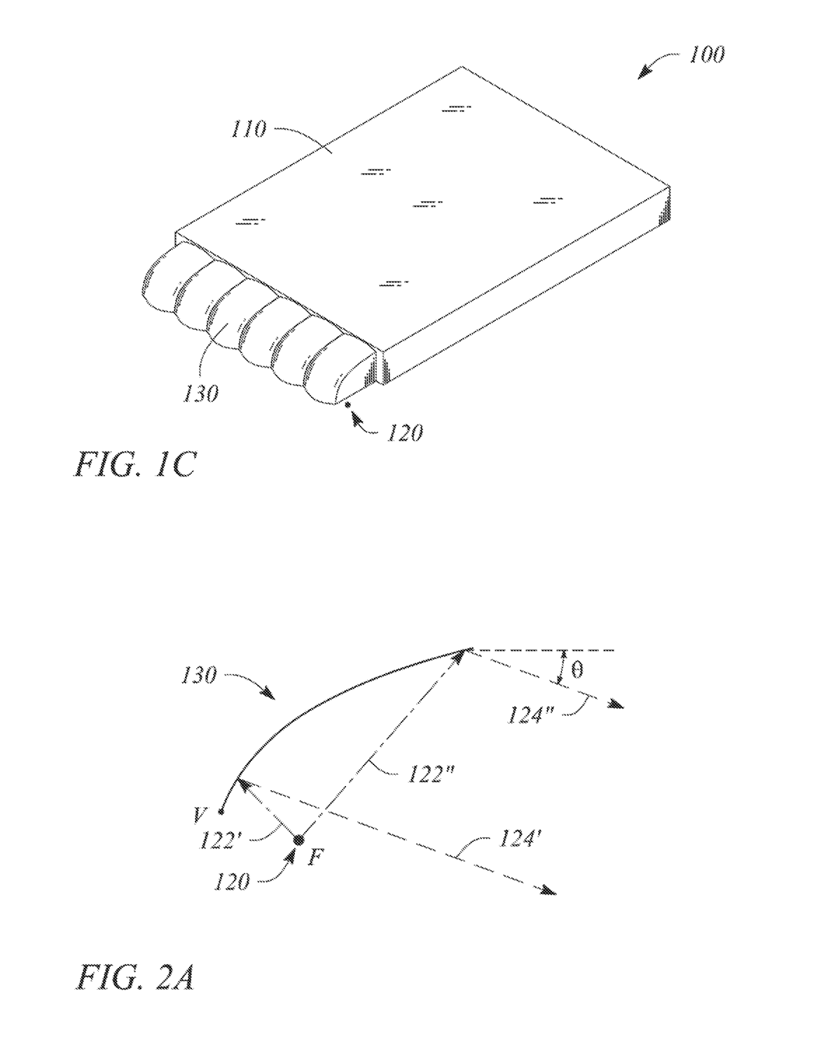

In accordance with the principles described herein, a backlight having a collimating reflector is provided. FIG. 1A illustrates a cross sectional view of a backlight 100, according to an example consistent with the principles described herein. FIG. 1B illustrates a plan view of a portion of the backlight 100 illustrated in FIG. 1A, according to an example consistent with the principles described herein. In particular, the plan view of FIG. 1B is a view from a top of the backlight 100 illustrated in FIG. 1A. FIG. 1C illustrates a perspective view of the backlight 100 illustrated in FIG. 1A, according to an example consistent with the principles described herein.

According to various examples, the backlight 100 is configured to emit light from a surface of the backlight 100. For example, the light may be emitted as emitted light 102 from a top surface. In some examples, the top surface of the backlight 100 may be a substantially planar surface. According to various examples, the emitted light 102 is a portion of light guided within the backlight (i.e., guided light 104).

According to some examples, the backlight 100 is to be used in an electronic display and the emitted light 102 represents or is used to form a plurality of pixels of the electronic display. The emitted light 102 may be directed in a direction corresponding to a viewing direction of the electronic display, for example. In some examples, the electronic display is a two-dimensional (2-D) electronic display. In other examples, the electronic display may be a so-called ‘glasses free’ three-dimensional (3-D) display (e.g., a multiview display).

In some examples, the emitted light 102 may be substantially omnidirectional in a region (e.g., half-volume) above the top surface of the backlight 100. For example, the emitted light 102 may be emitted by scattering a portion of the guided light 104 within the backlight 100. The guided light 104 may be scattered at the top surface of the backlight 100 to produce the emitted light 102. Alternatively, scattering may take place within the backlight 100 or at a back or bottom surface of the backlight 100. In some examples, the emitted light 102 may be scattered using a diffuser (e.g., a prismatic diffuser) upon being or after being emitted from the top surface of the backlight 100. In some examples, the diffuser may provide further scattering of the emitted light 102.

In other examples, the emitted light 102 is emitted as a beam of light in a direction generally away from the backlight surface. The beam of emitted light 102 may be substantially directional as opposed to omnidirectional. In particular, the backlight 100 may be configured to produce a plurality of emitted light beams 102 that is emitted from the backlight surface toward an electronic display viewing direction, in some examples. Individual ones of the emitted light beams 102 may correspond to individual pixels of either the 2-D electronic display or the 3-D electronic display, in various examples. The emitted light beam 102 may have both a predetermined direction and a relatively narrow angular spread, according some examples.

In some examples, the emitted light beam 102 is configured to propagate away from the backlight 100 in a direction that is substantially perpendicular to the surface of the backlight 100. In some examples, the light beam 102 emitted by the backlight 100 may be substantially collimated, which may reduce cross coupling or ‘cross-talk’ between adjacent light beams. The reduced cross coupling may be particularly useful for 3-D display applications that are typically more sensitive to the effects of cross coupling, in some examples.

As illustrated in FIGS. 1A-1C, the backlight 100 includes a plate light guide 110. The plate light guide 110 is configured to guide light (e.g., from a light source 120, described below). In some examples, the plate light guide 110 guides the guided light 104 using total internal reflection. For example, the plate light guide 110 may include a dielectric material configured as an optical waveguide. The dielectric material may have a first refractive index that is greater than a second refractive index of a medium surrounding the dielectric optical waveguide. The difference in refractive indices may be configured to facilitate total internal reflection of the guided light 104 according to a guided mode of the plate light guide 110.

In particular, in some examples, the plate light guide 110 may be a slab or plate optical waveguide that is an extended, substantially planar sheet of dielectric material (e.g., as illustrated in cross section in FIG. 1A and from the top in FIG. 1B). The substantially planar sheet of dielectric material is configured to guide the guided light 104 through total internal reflection. In some examples, the plate light guide 110 may include a cladding layer on a surface of the plate light guide 110 (not illustrated). The cladding layer may be used to further facilitate total internal reflection, for example. In some examples, the guided light 104 that is guided in the plate light guide 110 may propagate along or across an entire length of the plate light guide 110. According to various examples, the plate light guide 110 may include or be made up of any of a variety of dielectric materials including, but not limited to, various types of glass (e.g., silica glass) and transparent plastics (e.g., acrylic, polystyrene, etc.).

As further illustrated in FIG. 1A, the guided light 104 propagates along the plate light guide 110 in a generally horizontal direction, e.g., from the light source 120 near an end of the plate light guide 110 toward an opposite end thereof (e.g., as indicated by a hollow arrow in FIG. 1A). Propagation of the guided light 104 is illustrated in FIGS. 1A and 1B as a crosshatched region representing a propagating optical beam within the light guide 110. FIG. 1B illustrates a single propagating optical beam of guided light 104 for ease of illustration and not by way of limitation. The propagating optical beam illustrated in FIGS. 1A and 1B may represent plane waves of propagating light associated with the optical mode of the light guide 110. The optical beam of the guided light 104 is further illustrated in FIG. 1A as ‘bouncing’ or reflecting off of walls of the light guide 110 at an interface between the material (e.g., dielectric) of the light guide 110 and the surrounding medium to represent total internal reflection responsible for guiding the guided light 104.

According to various examples, the backlight 100 further includes a light source 120 to produce light. In various examples, the light source 120 may be substantially any source of light including, but not limited to, one or more of a light emitting diode (LED), a fluorescent light and a laser. For example, the light source 120 may include a plurality of separate LEDs arranged in a row or strip at or in a vicinity of an edge of the plate light guide 110. A portion of a row of individual sources of light (e.g., LEDs) is illustrated as the light source 120 in FIG. 1B, for example. In other examples, the light source 120 may be bar light (e.g., a fluorescent tube) or another strip light (e.g., an LED strip light).

In some examples, the light source 120 may produce a substantially monochromatic light having a narrowband spectrum denoted by a particular color. In particular, the color of the monochromatic light may be a primary color of a particular color gamut or color model (e.g., a red-green-blue (RGB) color model). The light source 120 may include a red LED such that the monochromatic light is substantially red light. In another example, the light source 120 may include a green LED such that the monochromatic light produced is substantially green in color. In yet another example, the light source 120 may include a blue LED such that the monochromatic light is substantially blue in color.

In other examples, light provided by the light source 120 has a substantially broadband spectrum. For example, the light produced by the light source 120 may be white light. The light source 120 may be a fluorescent light that produces white light. In another example, a plurality of different colored lights may be combined to provide the white light. For example, the light source 120 may be made up of a combination of a red LED, a green LED and blue LED that together represent a broad spectrum, substantially white light source 120.

According to various examples, the backlight 100 illustrated in FIGS. 1A-1C further includes a collimating reflector 130. The collimating reflector 130 is configured to substantially collimate the light produced by the light source 120, according to various examples. Further, as illustrated in FIG. 1A, the collimating reflector 130 is configured to direct the collimated light into the plate light guide 110, according to various examples. According to various examples, the collimated light directed by the collimating reflector 130 into the plate light guide 110 is the guided light 104 of the plate light guide 110. The top view illustrated in FIG. 1B depicts that collimated guided light 104 propagating with substantially little divergence from one end of the plate light guide 110 to another.

According to some examples, the collimating reflector 130 is configured to direct the collimated light at an angle θ relative to top and bottom surfaces of the plate light guide 110. In various examples, the angle θ may be both greater than zero and less than a critical angle of total internal reflection within the plate light guide 110. For example, if the critical angle is about 45 degrees, the angle θ may be between about 1 degree and about 40 degrees. In another example, the angle θ may be between about 10 degrees and 35 degrees. The angle d may be about 30 degrees. In some examples, the collimating reflector 130 is tilted or canted relative to a plane of the plate light guide 110 to direct the collimated light at the angle θ. In another example, the collimated reflector 130 is not tilted but instead is a shaped paraboloid reflector with a surface shaped according to equation (1) above to direct the collimated light at the angle θ.

In some examples, the collimating reflector 130 may have a substantially parabolic shape to collimate the light produced by the light source 120. The light source 102 (e.g., an LED) may be located at or near a focus of a parabola that describes the parabolic shape of the collimating reflector 130 (i.e., a focal point of the collimating reflector). Light diverging from the light source 102 may be collected and redirected or reflected by the parabolic shape of the collimating reflector 130 as a collimated beam of light, according to various examples. In some examples, the collimating reflector 130 may be employed in a so-called offset feed configuration where the collimating reflector 130 represents a portion of the parabola describing the parabolic shape that is away from a vertex of the parabola.

In some examples, the parabolic shape of the collimating reflector 130 represents a singly curved parabolic surface. The collimating reflector 130 may be a portion of a parabolic cylinder. In various other examples, parabolic shape of the collimating reflector 130 may be or be represented by a doubly curved paraboloid. The doubly curved paraboloid may have a first parabolic shape to collimate light in a first direction and a second parabolic shape to collimate light in a second direction. The first and second directions may be substantially orthogonal to one another.

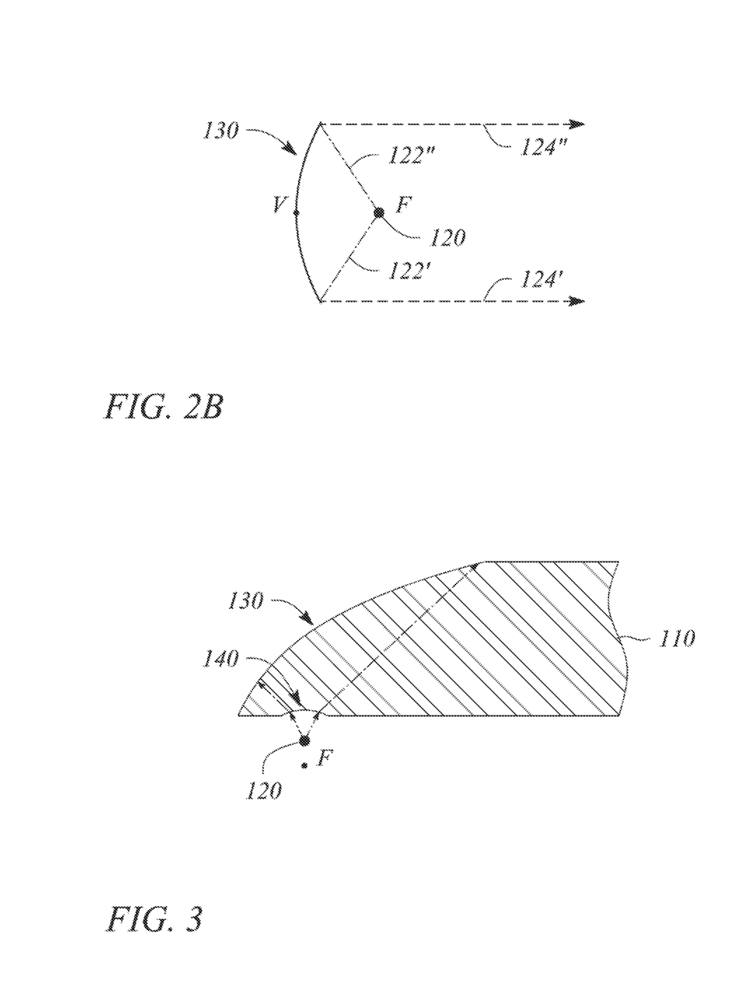

FIG. 2A illustrates a schematic representation of a parabolic shaped collimating reflector 130 in a first plane, according to an example consistent with the principles described herein. In particular, the first plane passes through a focal point F and a vertex V of the parabolic shaped collimating reflector 130, as illustrated. Further, the parabolic shaped collimating reflector 130 illustrated in FIG. 2A represents an offset feed configuration with respect to a light source 120 located at the focal point F.

FIG. 2B illustrates a schematic representation of the parabolic shaped collimating reflector 130 of FIG. 2A in a second plane, according to an example consistent with the principles described herein. In particular, the second plane is orthogonal to the first plane (e.g., the first plane is a horizontal plane, the second plane is a vertical plane). As illustrated in FIG. 2B, the light source 120 is located to illuminate the parabolic shaped collimating reflector 130 in a substantially non-offset feed configuration. Light produced by the light source 120 diverges as a cone of light denoted by rays 122′, 122″ in FIGS. 2A and 2B. Collimated light exiting the parabolic shaped collimating reflector 130 is denoted by rays 124′, 124″. Note that the parabolic shaped collimating reflector 130 not only collimates the light but also directs the light slightly downward at the non-zero angle θ, as illustrated in FIG. 2A.

Referring again to FIGS. 1A-1C, according to some examples of the backlight 100, the collimating reflector 130 may be integral to the plate light guide 110. In particular, the collimating reflector 130 may not be substantially separable from the plate light guide 110, for example. In some examples, the integral collimating reflector 130 may be formed from a material of the plate light guide 110. For example, both of the integral collimating reflector 130 and the plate light guide 110 may be formed by injection molding a material that is continuous between the collimating reflector 130 and the plate light guide 110. The material of both of the collimating reflector 130 and the plate light guide 110 may be injection-molded acrylic.

According to some examples, the collimating reflector 130 may further include a reflective coating on the parabolic shaped (curved) surface of the material used to form the collimating reflector 130. A metallic coating (e.g., an aluminum film) or a similar ‘mirroring’ material may be applied to an outside surface of a curved portion of the material that forms the collimating reflector 130 to enhance a reflectivity of the surface. In examples that include the collimating reflector 130 integral to the plate light guide 110, the backlight 100 may be referred to as a ‘monolithic’ backlight 100 herein.

In some examples, the backlight 100 further includes a lens between the light source 120 and the collimating reflector 130. In some examples, the lens is a negative lens. The negative lens may be employed to increase a divergence of light emitted by the light source 120. Increasing the light divergence may allow the light source 120 to be positioned closer to the collimating reflector 130. In other examples, the lens may be a positive lens. A positive lens may be used to partially or completely collimate light from the light source in one or both of a first direction (e.g., corresponding to a vertical direction) and a second direction (e.g., corresponding to a horizontal direction). Partial collimation using the lens may facilitate realizing the collimating reflector 130 by reducing an amount of collimation that is provided by the collimating reflector 130. In yet other examples, the lens may be an aspheric lens.

FIG. 3 illustrates a cross sectional view of a lens 140 between the collimating reflector 130 and the light source 120, according to an example consistent with the principles described herein. As illustrated, the lens 140 represents a single surface, negative lens 140. The divergence provided by the presence of the negative lens 140 allows the light source 120 to be located closer to the collimating reflector 130 than without the negative lens 140. The light source 120 may be moved to a position away from the focal point F so that the light source 120 is closer to the collimating reflector 130 due to the negative lens 140, as illustrated. In other examples, the lens 140 is a positive lens (not illustrated), as mentioned above.

In some examples, the lens 140 may be integral to the plate light guide 110. In some examples, the integral lens 140 may be formed from a material of the plate light guide 110. Both of the integral lens 140 and the plate light guide 110 may be formed by injection molding a material that is continuous between the lens 140 and the plate light guide 110. The material of both of the lens 140 and the plate light guide 110 may be injection-molded acrylic, for example. FIG. 3 illustrates the lens 140 as an integral lens 140 as well as the integral collimating reflector 130.

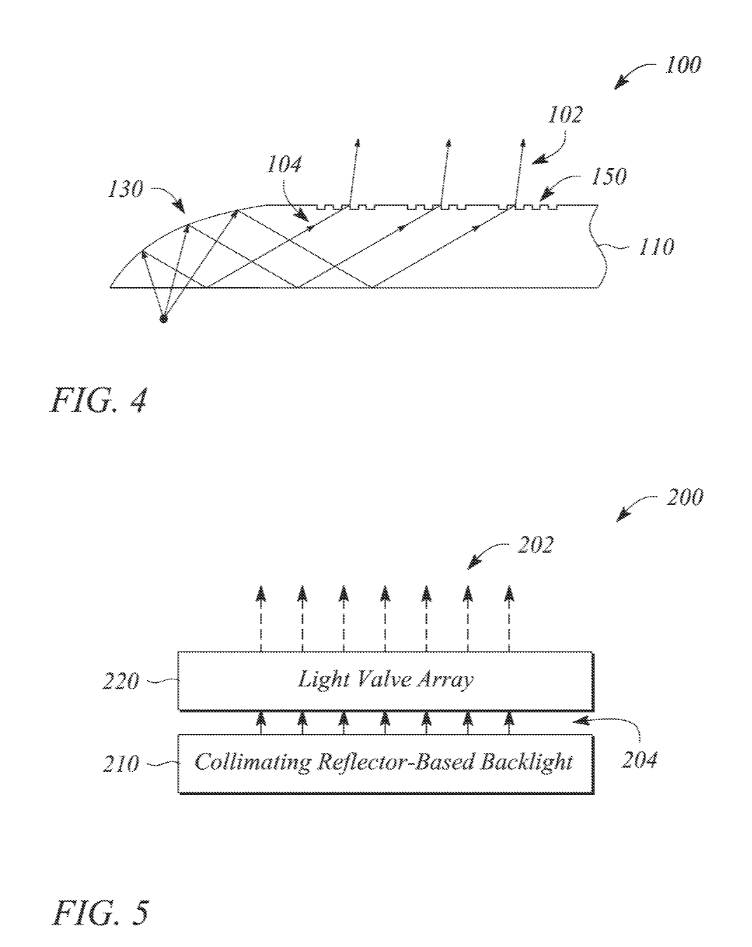

According to some examples, the backlight 100 may further include a diffraction grating. When included, the diffraction grating may be configured to couple out a portion of the guided light 104 from the plate light guide 110 by diffractive coupling. According to various examples, diffractive coupling couples out a portion of the guided light 104 in a direction that is different from a general direction of propagation in the plate light guide 110. The coupled out portion of the guided light 104 may be directed away from a surface of the plate light guide 110 at a diffraction angle relative to the plate light guide 110. The diffraction angle may be between 60 and 120 degrees, for example. In some examples, the diffraction angle may be about 90 degrees (i.e., normal to a surface of the plate light guide 110). FIG. 4 illustrates a cross sectional view of a portion of the backlight 100 including a diffraction grating 150, according to an example consistent with the principles described herein. As illustrated, the coupled out portion of the guided light 104 is the emitted light 102.

According to various examples, the diffraction grating 150 is located at a surface of the plate light guide 110. In particular, the diffraction grating 150 may be formed in a surface of the plate light guide 110, in some examples. For example, the diffraction grating 150 may include a plurality of grooves or ridges that either penetrate into or extend from, respectively, the surface of the plate light guide 110. The grooves may be milled or molded into the surface, for example. As such, a material of the diffraction grating 150 may be a material of the plate light guide 110, according to some examples. As illustrated in FIG. 4, the diffraction grating 150 includes parallel grooves that penetrate the surface of the light guide 110. In other examples (not illustrated), the diffraction grating 150 may be a film or layer applied or affixed to the light guide surface. In some examples, the grooves or ridges are substantially perpendicular to a propagation direction of the guided light 104 in the plate light guide 110. In other examples, the grooves or ridges may be oriented on the surface of the light guide at slant to the propagation direction (e.g., an angle other than perpendicular).

In some examples, the backlight 100 is substantially transparent. In particular, the plate light guide 110 and any diffraction grating 150 on a surface of the plate light guide 110 may be optically transparent in a direction orthogonal to a direction of guided light propagation within the plate light guide 110, according to some examples. Optical transparency may allow objects on one side of the backlight 100 to be seen from an opposite side.

FIG. 5 illustrates a block diagram of an electronic display 200, according to an example consistent with the principles described herein. In particular, the electronic display 200 illustrated FIG. 5 may be either a two-dimensional (2-D) electronic display or a three-dimensional (3-D) electronic display. According to various examples, the electronic display 200 is configured to emit light beams 202 that are modulated as pixels of the electronic display 200. Further, in various examples, the emitted light beams 202 may be preferentially directed toward a viewing direction of the electronic display 200. Modulation of the emitted light beams 202 of the electronic display 200 is illustrated using dashed lines in FIG. 5.

The electronic display 200 illustrated in FIG. 5 includes a collimating reflector-based backlight 210. According to various examples, the collimating reflector-based backlight 210 serves as a source of light 204 for the electronic display 200. Further, the collimating reflector-based backlight 210 serves as a source of color for the electronic display 200, in some examples. In particular, some of the emitted light beams 202 from the electronic display 200 may have a different color than other emitted light beams 202 as provided by the light 204 emitted by the collimating reflector-based backlight 210, according to some examples. According to various examples, the collimating reflector-based backlight 210 may be substantially similar to the backlight 100, described above.

In particular, according to some examples, the collimating reflector-based backlight 210 includes a plate light guide. The plate light guide may be substantially similar to the plate light guide 110 described above with respect to the backlight 100, in some examples. Further, the collimating reflector-based backlight 210 includes a collimating reflector configured to substantially collimate light produced by a light source and to direct the collimated light into the plate light guide at a non-zero angle relative to a top surface and a bottom surface of the plate light guide. The collimated light is directed into the plate light guide at the non-zero angle and is guided within the plate light guide, according to various examples. In some examples, the collimating reflector is substantially similar to the collimating reflector 130 described above with respect to the backlight 100.

In some examples, the collimating reflector-based backlight 210 further includes a plurality of diffraction gratings at the top surface of the plate light guide. The diffraction gratings are configured to diffractively couple out different portions of the collimated light guided within the plate light guide as a corresponding plurality of light beams 204. In some examples, a diffraction grating of the plurality is substantially similar to the diffraction grating 150 described above with respect to the backlight 100. Moreover, the light beams 204 of the emitted light produced by the diffraction gratings through diffractive coupling may correspond to the emitted light 102 described above with respect to the backlight 100.

In some examples, the collimating reflector-based backlight 210 further includes the light source. According to some examples, the light source is substantially similar to the light source 120 described above with respect to the backlight 100. In particular, the light source may include a plurality of light emitting diodes (LEDs) arranged underneath and in a vicinity of an edge of the plate light guide to illuminate the collimating reflector (e.g., a similar plurality of collimating reflectors at the edge).

Referring again to FIG. 5, the electronic display 200 further includes a light valve array 220, according to various examples. The light valve array 202 includes a plurality of light valves configured to modulate the light beams 204 from the collimating reflector-based backlight 210 as emitted light 202, according to various examples. In various examples, different types of light valves may be employed in the light valve array 220 including, but not limited to, liquid crystal light valves and electrophoretic light valves.

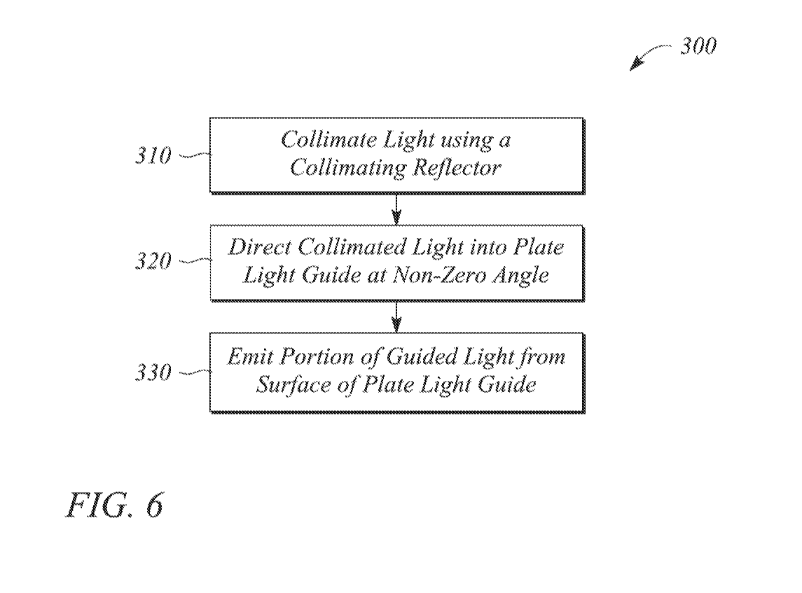

Further according to the principles described herein, a method of backlighting is provided. FIG. 6 illustrates a flow chart of a method 300 of backlighting, according to an example consistent with the principles described herein. As illustrated, the method 300 of backlighting includes collimating 310 light using a collimating reflector. According to various examples, the light is provided by a light source. In some examples, the collimating reflector is at an edge of a plate light guide and the light source at a focal point of the collimating reflector. The light provided by the light source, which is initially propagating in a substantially vertical direction, may be redirected by the collimating reflector in a substantially horizontal direction, in some examples. In some examples, the collimating reflector used in collimating 310 light may be substantially similar to the collimating reflector 130; the plate light guide may be substantially similar to the plate light guide 110; and the light source may be substantially similar to the light source 120, all described above with respect to the backlight 100. For example, the plate light guide may be a substantially planar dielectric optical waveguide.

The method 300 of backlighting further includes directing 320 the collimated light into the plate light guide edge using the collimating reflector. In particular, the collimated light is directed 320 into the plate light guide at a non-zero angle relative to a surface of the plate light guide. The non-zero angle is less than a critical angle to provide total internal reflection of the collimated light within the plate light guide, according to various examples. As such, the collimated light directed 320 into the plate light guide at the non-zero angle is guided by the plate light guide. The non-zero angle may be provided by tilting the collimating reflector, for example. In another example, the non-zero angle may be provided by a shaped paraboloid reflector, e.g., see equation (1).

The method 300 of backlighting further includes emitting 330 a portion of the guided light from the surface of the plate light guide. In some examples, emitting 330 a portion of the guided light is provided by diffractively coupling out the portion of the guided light using a diffraction grating. According to various examples, the diffraction grating is substantially similar to the diffraction grating 150 described above with respect to the backlight 100.

In some examples, the collimating reflector used in collimating 310 light and then directing 320 the collimated light into the plate light guide is a parabolic reflector. In some examples, the parabolic reflector includes a doubly curved paraboloid having a first parabolic shape to collimate light in a first direction and a second parabolic shape to collimate light in a second direction. In some examples, the first and second directions are substantially orthogonal to one another. The first direction may be substantially perpendicular to a top surface and a bottom surface of the plate light guide, while the second direction may be substantially parallel to the top and bottom surfaces. In some examples, the collimating reflector is integral to and formed from a material of the plate light guide.

Thus, there have been described examples of a backlight, an electronic display and a method of operating a backlight that employ a reflector to collimate and direct light into a plate light guide. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A backlight comprising:
a plate light guide to guide light;
a light source to produce light; and
a collimating reflector to collimate the light produced by the light source and to direct the collimated light into the plate light guide, the collimated light directed into the plate light guide being guided light of the plate light guide.
wherein the backlight is to emit a portion of the guided light as emitted light from a surface of the backlight.

2. The backlight of claim 1, wherein the plate light guide comprises a sheet of dielectric material to guide the guided light by total internal reflection.

3. The backlight of claim 1, wherein the collimating reflector is to direct the collimated light at an angle θ relative to a top surface and a bottom surface of the plate light guide, the angle θ being both greater than zero and less than a critical angle of total internal reflection within the plate light guide.

4. The backlight of claim 1, wherein the collimating reflector has a substantially parabolic shape to substantially collimate the light produced by the light source.

5. The backlight of claim 4, wherein the parabolic shape of the collimating reflector represents a portion of a doubly curved paraboloid reflector having a first parabolic shape to collimate light in a first direction and a second parabolic shape to collimate light in a second direction, the first and second directions being substantially orthogonal to one another.

6. The backlight of claim 1, wherein the collimating reflector is integral to and formed from a material of the plate light guide.

7. The backlight of claim 1, further comprising a lens between the light source and the collimating reflector, the lens being integral to and formed from a material of the plate light guide.

8. The backlight of claim 1, further comprising a diffraction grating at the surface of the plate light guide, the diffraction grating to diffractively couple a portion of the guided light from the plate light guide to produce the emitted light, wherein the diffraction grating comprises one or both of grooves in a surface of the plate light guide and ridges protruding from the plate light guide surface, the grooves and ridges being arranged parallel to one another and substantially perpendicular to a propagation direction of the guided light within the plate light guide.

9. An electronic display comprising the backlight of claim 1, wherein the emitted light of the backlight is light corresponding to a pixel of the electronic display.

10. An electronic display comprising:
a collimating reflector-based backlight comprising:
a plate light guide;
a collimating reflector to substantially collimate light produced by a light source and to direct the collimated light into the plate light guide at a non-zero angle relative to a top surface and a bottom surface of the plate light guide; and
a plurality of diffraction gratings at the top surface of the plate light guide, the diffraction gratings to diffractively couple out different portions of the collimated light guided within the plate light guide as a corresponding plurality of light beams; and
a light valve array to modulate the light beams coupled out by the diffraction gratings, the modulated light beams representing pixels of the electronic display.

11. The electronic display of claim 10, further comprising the light source comprising a plurality of light emitting diodes arranged at an edge of the plate light guide.

12. The electronic display of claim 10, wherein the collimating reflector is integral to and formed from a material of the plate light guide, the collimating reflector comprising a portion of a doubly curved paraboloid reflector having a first parabolic shape to collimate light in a first direction parallel to a surface of the plate light guide and a second parabolic shape to collimate light. In a second direction substantially orthogonal to the first direction.

13. The electronic display of claim 10, wherein the light valve array comprises an array of liquid crystal light valves, the electronic display being a three-dimensional backlit liquid crystal display.

14. A method of backlighting, the method comprising:
collimating light using a collimating reflector at an edge of a plate light guide, the light being provided by a light source;
directing the collimated light into the plate light guide edge using the collimating reflector, the collimated light directed Into the plate light guide being guided by the plate light guide; and
emitting a portion of the guided light from a surface of the plate light guide,
wherein the collimated light is directed into the plate light guide at a non-zero angle relative to the surface of the plate light guide.

15. The method of backlighting of claim 14, wherein the collimating reflector comprises a portion of a doubly curved paraboloid reflector having a first parabolic shape to collimate light in a first direction and a second parabolic shape to collimate light in a second direction, the first and second directions being substantially orthogonal to one another, the collimating reflector being integral to and formed from a material of the plate light guide.
